(19) United States
(12) Patent Application Publication
(10) Pub. No.: US 2011/0228415 A1
(43) Pub. Date: Sep. 22, 2011

(54) HIGH-REFLECTION MULTILAYER COATING

(76) Inventors: Shih-Chang SHEI, Tainan City (TW); Nan-Ming LIN, Lujhu Township (TW); Ray CHIANG, Tainan City (TW)

(21) Appl. No.: 12/727,029

(22) Filed: Mar. 18, 2010

(51) Int. Cl. G02B 5/08

(52) U.S. Cl. 359/883

(57) ABSTRACT

A high-reflection multilayer coating, which includes a baseplate, a reflecting layer and a composite reflecting layer, in which the reflecting layer is contiguously disposed between the baseplate and the composite reflecting layer, and the composite reflecting layer is provided with a first structure layer and a second structure layer. Moreover, the first structure is mutually contiguously disposed on the reflecting layer. Accordingly, the present invention is able to achieve 95˜100% high light reflectivity over a wavelength range of 400˜800 nanometers, thus increasing light reflectivity and extending the range of reflection. The present invention is able to increase the degree of illumination, brightness and uniformity when used in various types of lamps.

### BACKGROUND OF THE INVENTION

(a) Field of the Invention

The present invention relates to a high-reflection multilayer coating, and more particularly to a high-reflection multilayer coating that can be used in all types of lamps, optical mirrors or for light reflecting and condensing use.

(b) Description of the Prior Art

Quality of the reflection structure is the largest key factor in progressing towards high quality and high efficiency for current lighting systems. Referring to FIG. 1, which shows a reflection structure (3) of the prior art, wherein a reflecting layer (32) is disposed on the surface of a baseplate (31) using electron beam evaporation. Material for the reflecting layer (32) is common aluminum and silver. In which, optimum reflectivity of the silver reflecting layer (32) can achieve 90˜95% in a wavelength range of visible light to infrared light (wave lengths of 400˜800 nanometers).

However, the reflecting layer (32) of silver material very easily oxidizes, with an oxide layer forming on the surface after air contact, causing reflectivity to drop, even resulting in the reflecting layer (32) flaking off. Hence, the surface of the reflecting layer (32) of silver material of the prior art structure is additionally coated with a protective layer (33) of silicon dioxide. And although the protective layer (33) can prevent oxidization of the reflecting layer (32), however, it is unable to improve reflection effectiveness, but instead causes a reduction in reflectivity of the reflecting layer (32).

### SUMMARY OF THE INVENTION

In light of the above, a primary objective of the present invention is to provide a high-reflection multilayer coating able to increase light reflectivity.

Another objective of the present invention is to increase the wavelength range of high light reflectivity.

In order to achieve the aforementioned objectives, the present invention provides a high-reflection multilayer coating, in which the high-reflection multilayer coating comprises a baseplate, a reflecting layer and a composite reflecting layer. The reflecting layer is contiguously disposed between the baseplate and the composite reflecting layer. The composite reflecting layer is provided with a first structure layer and a second structure layer, and the first structure is mutually contiguously disposed on the reflecting layer.

The reflecting layer of silver material of the present invention is coated with the composite reflecting layer of silicon dioxide and titanium dioxide, thereby improving reflection effectiveness to achieve 95˜100% reflectivity.

Moreover, the wavelength range achievable for 95˜100% high light reflectivity attained by the present invention can be increased to cover a wavelength range of visible light to infrared light (wave lengths of 400˜800 nanometers).

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a cross sectional view of a prior art structure.

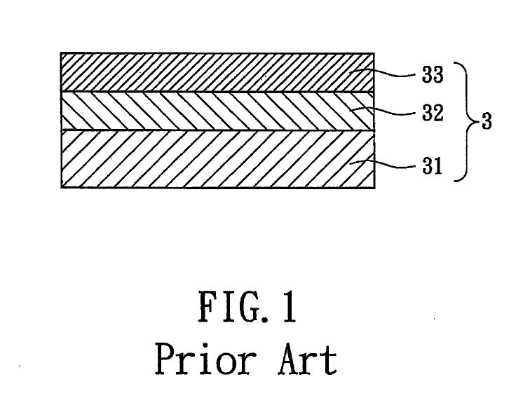

FIG. 2 is a cross sectional view of a first embodiment of the present invention.

FIG. 3 shows reflectivity curve comparison graphs for the present invention and prior art structures.

FIG. 4 is a cross sectional view of a second embodiment of the present invention.

### DETAILED DESCRIPTION OF THE PREFERRED EMBODIMENTS

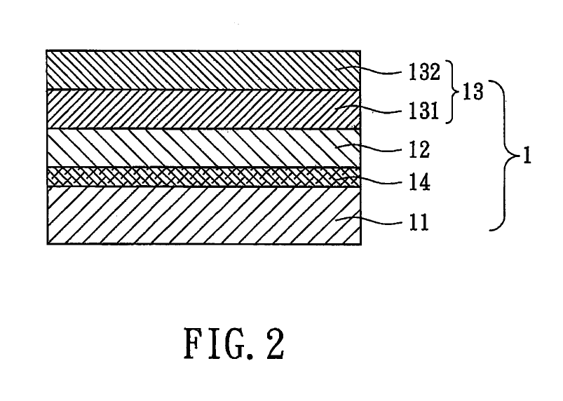

The present invention relates to a high-reflection multilayer coating. Referring to FIG. 2, which shows a high-reflection multilayer coating (1) of the present invention comprising a baseplate (11), a reflecting layer (12) and a composite reflecting layer (13). The reflecting layer (12) is contiguously disposed between the baseplate (11) and the composite reflecting layer (13).

The baseplate (11) can be selected from stainless steel, aluminum, aluminum magnesium alloy or glass material. Moreover, the surface of the baseplate (11) contiguous to the reflecting layer (12) can be a plane surface, a convex surface, a concave surface or a non-planar surface provided with protruding portions.

The reflecting layer (12) can be selected from silver material, and it is preferred to use an electron beam evaporation method to join the reflecting layer (12) to the baseplate (11).

The composite reflecting layer (13) is fabricated from a first structure layer (131) and a second structure layer (132), and it is preferred to use an electron beam evaporation method for sequential joining to the reflecting layer (12). The first structure layer (131) is a silicon dioxide (SiO₂) material, the second structure layer (132) is a titanium dioxide (TiO₂) material, and the first structure layer (131) is contiguously joined to the reflecting layer (12).

In addition, an attachment layer (14) can be additionally interposed between the baseplate (11) and the reflecting layer (12), the attachment layer (14) being selected from chromium (Cr) material. The attachment layer (14) enables improving the degree of combining between the reflecting layer (12) and the baseplate (11) to prevent the reflecting layer (12) from flaking off.

The present invention consists of coating the reflecting layer (12) of silver material with the composite reflecting layer (13) of silicon dioxide and titanium dioxide, which apart from providing a protective medium for the reflecting layer (12), reflectivity is also improved. For example: improvement in reflectivity to 95˜100% can be effected in a range from visible light to infrared light (wave lengths of 400˜800 nanometers).

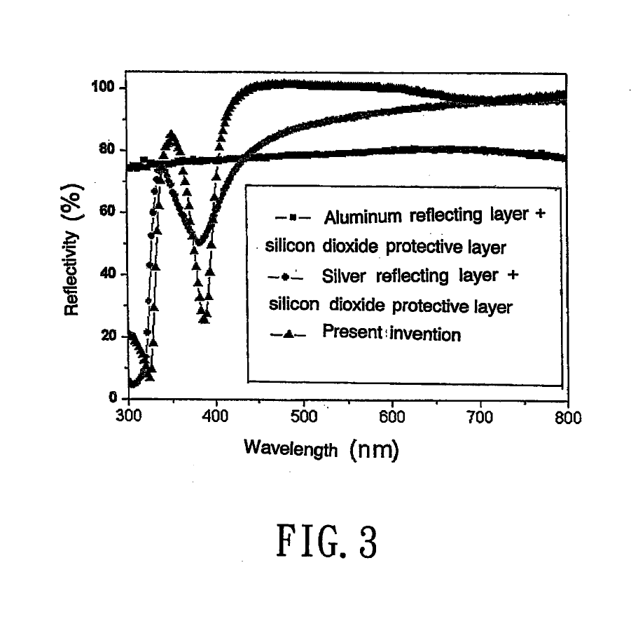

Referring to FIG. 3, which depicts graphs of reflectivity results for the present invention and prior art structures, in which reflectivity results of a prior art structure 1 (aluminum reflecting layer+silicon dioxide protective layer) and a prior art structure 2 (silver reflecting layer+silicon dioxide protective layer) are compared with reflectivity results of the present invention.

The present invention achieves 95˜100% reflectivity in a wavelength range of 400˜800 nanometers, whereas reflectivity of the prior art structure 1 is lower than 80%, while the prior art structure 2 only achieves over 95% reflectivity in a wavelength range of 700˜800 nanometers.

Hence, it can be understood that the present invention is able to achieve 95˜100% reflectivity within a larger wavelength range, thereby increasing light reflectivity and extending the range of reflection. Hence, the present invention is able to increase the degree of illumination, brightness and uniformity when used in various types of lamps.

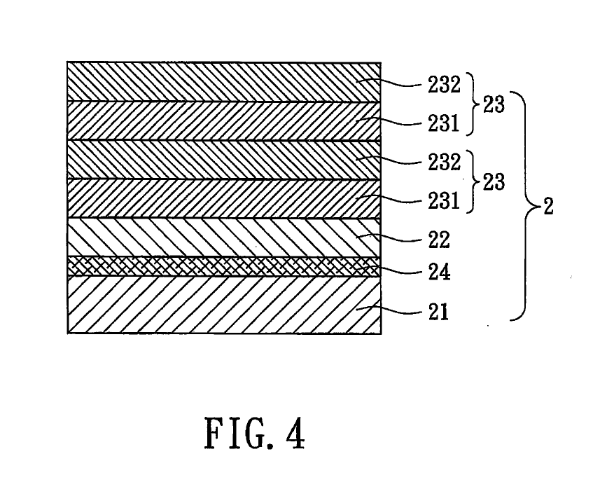

Referring to FIG. 4, which shows a second embodiment of the present invention depicting a high-reflection multilayer coating (2) comprising a baseplate (21), a reflecting layer (22) and two composite reflecting layers (23), wherein the two composite reflecting layers (23) are mutually contiguously disposed. The reflecting layer (22) is contiguously disposed between the baseplate (21) and the composite reflecting layers (23). Moreover, an attachment layer (24) is additionally disposed between the baseplate (21) and the reflecting layer (22).

The structure and materials of the baseplate (21), the reflecting layer (22) and the attachment layer (24) of the second embodiment of the present invention are the same as those for the aforementioned first embodiment. However, the second embodiment of the present invention is provided with at least two composite reflecting layers (23), and each of the composite reflecting layers (23) is fabricated from a first structure layer (231) and a second structure layer (232). The two first structure layers (231) are made from silicon dioxide (SiO₂) material, and the two second structure layers (232) are made from titanium dioxide (TiO₂) material. Moreover, the two first structure layers (231) and the two second structure layers (232) are disposed so as to be mutually staggered, in which one of the first structure layers (231) is contiguously joined to the reflecting layer (22).

In conclusion, the present invention surely provides the above advantages, and has evident advancement in effectiveness when compared to prior art structures. Moreover, the present invention is characterized in having originality compared to similar products, and thus clearly complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A high-reflection multilayer coating, comprising a baseplate, a reflecting layer and a composite reflecting layer, the reflecting layer is contiguously disposed between the baseplate and the composite reflecting layer, the composite reflecting layer is provided with a first structure layer and a second structure layer, and the first structure layer is contiguously joined to the reflecting layer.

2. The high-reflection multilayer coating according to claim 1, wherein the high-reflection multilayer coating is additionally disposed with at least one composite reflecting layer, and the at least one additionally disposed composite reflecting layer is provided with a first structure layer and a second structure layer; each of the first structure layers and the second structure layers are disposed so as to be mutually staggered, in which one of the first structure layers is contiguously joined to the reflecting layer.

3. The high-reflection multilayer coating according to claim 1, wherein the surface of the baseplate contiguous to the reflecting layer is a plane surface, a convex surface, a concave surface or a non-planar surface provided with protruding portions.

4. The high-reflection multilayer coating according to claim 2, wherein the surface of the baseplate contiguous to the reflecting layer is a plane surface, a convex surface, a concave surface or a non-planar surface provided with protruding portions.

5. The high-reflection multilayer coating according to claim 1, wherein an attachment layer is disposed between the baseplate and the reflecting layer, the material of the attachment layer is chromium.

6. The high-reflection multilayer coating according to claim 2, wherein an attachment layer is disposed between the baseplate and the reflecting layer, the material of the attachment layer is chromium.

7. The high-reflection multilayer coating according to claim 1, wherein the material of the reflecting layer is silver.

8. The high-reflection multilayer coating according to claim 2, wherein the material of the reflecting layer is silver.

9. The high-reflection multilayer coating according to claim 1, wherein the material of the first structure layer is silicon dioxide.

10. The high-reflection multilayer coating according to claim 2, wherein the material of the first structure layer is silicon dioxide.

11. The high-reflection multilayer coating according to claim 1, wherein the material of the second structure layer is titanium dioxide.

12. The high-reflection multilayer coating according to claim 2, wherein the material of the second structure layer is titanium dioxide.
